(19) United States
(12) Patent Application Publication
(10) Pub. No.: US 2012/0016606 A1
(43) Pub. Date: Jan. 19, 2012

(54) Power Profiling for Embedded System Design

(76) Inventors: Emmanuel Petit, Chevreuse (FR); Mohamed Shalan, Cairo (EG)

(21) Appl. No.: 13/035,881

(22) Filed: Feb. 25, 2011

Related U.S. Application Data
(60) Provisional application No. 61/307,868, filed on Feb. 25, 2010.

(51) Int. Cl. G06F 19/00

(52) U.S. Cl. 702/61

(57) ABSTRACT

Tools and methods for profiling power consumption of an embedded system are provided. Power event and control modules, executable by the embedded system are provided. Additionally, a power measurement and control unit is provided that can measure the power consumption and limit the supply current to the embedded system. Furthermore, a power profiling tool is provided. The tool includes modules that interface with the power measurement and control unit and well as the power event and control modules. Then, power event and system data may be received by the power profiling tool from the embedded system and power consumption data may be received from the power measurement and control unit. Subsequently, power consumption metrics may be viewed by the power profiling tool.

### RELATED APPLICATIONS

This application claims priority under 35 U.S.C. §119(e) to U.S. Provisional Patent Application No. 61/307,868 entitled “Power Profiling for Embedded System Design” filed on Feb. 25, 2010, and naming Emmanuel Petit et al. as inventors, which application is incorporated entirely herein by reference.

### FIELD OF THE INVENTION

The invention relates to the design of embedded electronic systems. More specifically, various implementations of the invention are applicable to analyzing the power requirements for an embedded system

### BACKGROUND OF THE INVENTION

In general, an embedded system may be described as a special purpose computing system designed to perform one or a few dedicated functions. Embedded systems are commonly used in consumer devices like personal digital assistants, mobile phones, videogame consoles, microwaves, washing machines, alarm systems, and digital cameras. In addition to the consumer space, embedded systems are used in nearly every industry, from telecommunications to manufacturing, and from transportation to medical devices. In fact, embedded systems are so commonly in use today that it is not feasible to exhaustively list specific examples.

The term “embedded system” does not have a precise definition, and determining what is and is not an embedded system can be difficult. For example, a general purpose computer, such as a laptop, is not typically characterized as an embedded system. However, a laptop is usually composed of a multitude of subsystems such as the hard disk drive, the motherboard, the optical drive, the video processing unit, and various communication devices. Many of the individual subsystems comprising the laptop may themselves be embedded systems.

The complexity of embedded systems can vary from, for example, systems with a single microcontroller chip and a light emitting diode to systems with multiple microprocessor units and various peripheral communication interfaces and mechanical parts. Manufacturers of modern microprocessors are increasingly adding components and peripheral modules to their microprocessors, creating what may be thought of as embedded processors. This type of embedded system is often referred to as a system on a chip (SoC). A simple example of a system on chip is an application-specific integrated circuit (ASIC) packaged with a universal serial bus (USB) port. Additionally, embedded systems range from those having no user interface at all to those with full user interfaces similar to a desktop operating system.

There are many advantages to using embedded systems. For example, an embedded system typically is designed to do some specific task, as opposed to being a general purpose computer with a wide range of features for performing many different tasks. As a result, design engineers can optimize the embedded system for the desired task, which assists in reducing the size and cost of the device as well as increasing its reliability and performance. Furthermore, functionalities can be designed into an embedded system that would not be feasible using hardware alone.

By using software to accomplish some of the functionality that would have been accomplished in hardware, designers may specify and define certain functionality later in the design cycle than was previously possible. An additional advantage is that embedded system designs can often be reconfigured for different functionality with less engineering overhead than a design embodied entirely by hardware. As a result, design reuse can be increased, resulting in a reduced time to market.

The software written for embedded systems is generally referred to as “firmware.” Firmware is often stored on read only memory (“ROM”) based storage devices. For example, flash-based read only memory or electronically erasable read only memory (“EEPROM”) devices are often used to store firmware. The firmware controls the various features, functioning, and interfaces of the embedded system. Thus, a digital video disk player will have firmware that processes the appropriate response to an input, such as the user pressing the “power” button or the “play” button. Additionally, the firmware in this example would control the storage mechanism, the digital processing circuitry used to decode and output onto the appropriate ports the video and audio signals stored on the video storage medium, as well as the user interface allowing the user to configure settings of the digital video disk player.

Modern embedded systems often allow the user to execute an additional application, often referred to as an “app”, on the device. For example, an app may be loaded into a memory location accessible by the embedded systems firmware such that the app may be executed by the embedded systems firmware. The various instructions that the embedded system executes, such as, for example, the firmware or apps, are often referred to herein as “computer executable applications”. However, they may also be referred to herein as firmware, software, applications, programs, or apps.

Power consumption is typically of concern to the designers of an embedded system. Furthermore, power consumption is increasingly becoming important to users of embedded systems. For example, one reason that the power consumption of an embedded system powered from a rechargeable battery may be of concern is that the power consumption dictates how long it can be used without recharging the battery. Additionally, power consumption of embedded systems may be of concern for financial or environmental reasons.

One method designers have to analyze the power consumption of an embedded system is by using an oscilloscope, or some other passive measuring device, to collect power metrics, such as, for example, current drain and supply voltages. This method is limited in that the only metric available is the power consumption over time. Conventionally, where finer grained analysis of power consumption metrics is desired, designers typically resort to increasing the number of power consumption measuring points. Furthermore, designers will often resort to repeatedly switching on and off a selected hardware component to create an identifiable current drain pattern within the measured power metrics. This technique is often referred to as “in-band signaling.” These solutions require increased intrusion into the hardware for the embedded system. This typically requires the creations or manufacturing of special measuring devices as well as special prototype or reference boards that facilitate the increased number of power measurement points throughout the embedded system. Furthermore, modification of the embedded system firmware is typically required to carry out the various in-band signaling tests desired.

### BRIEF SUMMARY OF THE INVENTION

Various implementations of the present invention provide methods and apparatuses for profiling the power consumption of an embedded system.

In various implementations, a system event router and a power management module, which are executable by an embedded system, are provided. Additionally, a power measurement unit is configured to measure the power consumption of the embedded system. The embedded system is then operated. Subsequently, power event and system data is received by a power profiling tool from the system event router and the power management module. Additionally, power consumption measurement data is received by the power profiling tool.

The power profiling tool then, may compile the received measurement and power event data in a correlated fashion, generating a power consumption profile. Subsequently, the power consumption profile may be provided to a user of the power profile tool.

These and other features and aspects of the invention will be apparent upon consideration of the following detailed description of illustrative embodiments.

### BRIEF DESCRIPTION OF THE DRAWINGS

The present invention will be described by way of illustrative embodiments shown in the accompanying drawings in which like references denote similar elements, and in which:

FIG. 1 shows an illustrative embedded system;

FIG. 2 shows an illustrates operating environment;

FIG. 3 illustrates an power profiling system;

FIG. 4 shows a method of profiling power consumption of an embedded system;

FIG. 5 shows an illustrative power consumption profile; and

FIG. 6 shows an illustrative power consumption profile.

### DETAILED DESCRIPTION OF ILLUSTRATIVE IMPLEMENTATIONS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “generate” to describe the disclosed implementations. Such terms are often high-level abstractions of the actual operations that are performed. The actual operations that correspond to these terms will often vary depending on the particular implementation.

As stated above, various implementations of the invention provide methods and apparatuses for optimizing and verifying power consumption profiles for an embedded system. As such, brief overviews of an embedded system, as well as an illustrative operating environment suitable for practicing the invention are described below.

### Illustrative Embedded System

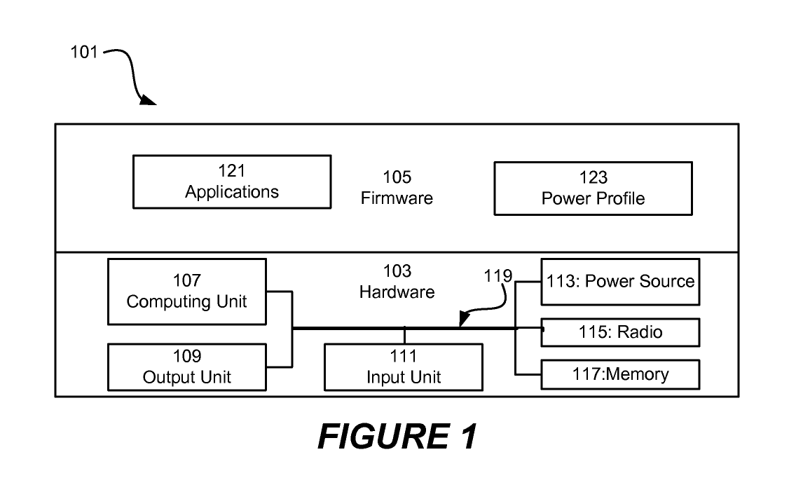

As detailed above, an embedded system is a combination of hardware and software, often designed for a particular task. FIG. 1 illustrates an embedded system 101. As can be seen from this figure, the embedded system 101 includes a hardware component 103 and firmware 105. As illustrated, the hardware component 103 includes a computing unit 107, an output unit 109, an input unit 111, a power source 113, a radio 115, and a memory 117. The hardware components are interconnected with a bus 119. Those of skill in the art will appreciate that not all embedded systems include the features illustrated in FIG. 1. Furthermore, additional features, not illustrated in FIG. 1, may be present in an embedded system.

The firmware 105 typically includes the drivers necessary for the functioning of the hardware 103 as well as various manufacturer provided applications and user interface software. As those of skill in the art will appreciate, applications 121 can be executed on the embedded system 101 to add or complement the functionality provided by the hardware 103 and the firmware 105.

As stated previously, embedded systems, such as, for example, the embedded system 101, can operate in a number of different power modes. More particularly, as those of skill in the art will appreciate, the various components of the hardware are often capable of operating in a number of different “power states.” For example, a typical computing unit 107 can operate at a number of different frequencies and voltage settings. These various settings are often referred to as operating points. Furthermore, various other components, such as, the output unit 109 may have a number of different power states. For example, if the output unit 109 were a liquid crystal display (LCD) device, then the unit 109 would typically be able to operate in a number of different brightness settings, in addition to having an “off” state as well as a “100%” on state.

Often, the firmware 105 includes a power profile 123 that controls the power supplied to the various components of the hardware 103. More particularly, the power profile 123 determines what power state each component should be in during operation of the device. As will be appreciated by those of skill in the art, during the operation of an embedded system, power consumption is significantly affected by the power state of the various hardware components.

### Illustrative Operating Environment

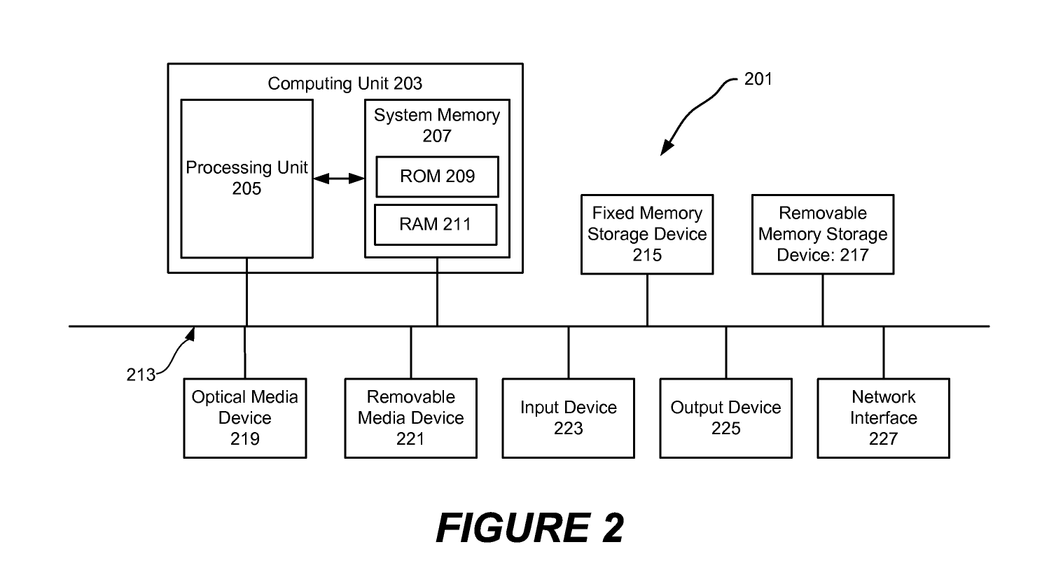

As the techniques of the present invention may be implemented using software instructions, the components and operation of a computer system on which various implementations of the invention may be employed is described. Accordingly, FIG. 2 shows an illustrative computing device 201. As seen in this figure, the computing device 201 includes a computing unit 203 having a processing unit 205 and a system memory 207. The processing unit 205 may be any type of programmable electronic device for executing software instructions, but will conventionally be a microprocessor. The system memory 207 may include both a read-only memory (“ROM”) 209 and a random access memory (“RAM”) 211. As will be appreciated by those of ordinary skill in the art, both the ROM 209 and the RAM 211 may store software instructions for execution by the processing unit 205.

The processing unit 205 and the system memory 207 are connected, either directly or indirectly, through a bus 213 or alternate communication structure, to one or more peripheral devices. For example, the processing unit 205 or the system memory 207 may be directly or indirectly connected to one or more additional devices, such as; a fixed memory storage device 215, for example, a magnetic disk drive; a removable memory storage device 217, for example, a removable solid state disk drive; an optical media device 219, for example, a digital video disk drive; or a removable media device 221, for example, a removable floppy drive. The processing unit 105 and the system memory 207 also may be directly or indirectly connected to one or more input devices 223 and one or more output devices 225. The input devices 223 may include, for example, a keyboard, a pointing device (such as a mouse, touchpad, stylus, trackball, or joystick), a scanner, a camera, and a microphone. The output devices 225 may include, for example, a monitor display, a printer and speakers. With various examples of the computing device 201, one or more of the peripheral devices 215-225 may be internally housed with the computing unit 203. Alternately, one or more of the peripheral devices 215-225 may be external to the housing for the computing unit 203 and connected to the bus 213 through, for example, a Universal Serial Bus (“USB”) connection.

With some implementations, the computing unit 203 may be directly or indirectly connected to one or more network interfaces 227 for communicating with other devices making up a network. The network interface 227 translates data and control signals from the computing unit 203 into network messages according to one or more communication protocols, such as the transmission control protocol (“TCP”) and the Internet protocol (“IP”). Also, the interface 227 may employ any suitable connection agent (or combination of agents) for connecting to a network, including, for example, a wireless transceiver, a modem, or an Ethernet connection.

It should be appreciated that the computing device 201 is shown here for illustrative purposes only, and it is not intended to be limiting. Various embodiments of the invention may be implemented using one or more computers that include the components of the computing device 201 illustrated in FIG. 2, which include only a subset of the components illustrated in FIG. 2, or which include an alternate combination of components, including components that are not shown in FIG. 2. For example, various embodiments of the invention may be implemented using a multi-processor computer, a plurality of single and/or multiprocessor computers arranged into a network, or some combination of both.

### Embedded System Power Profiling

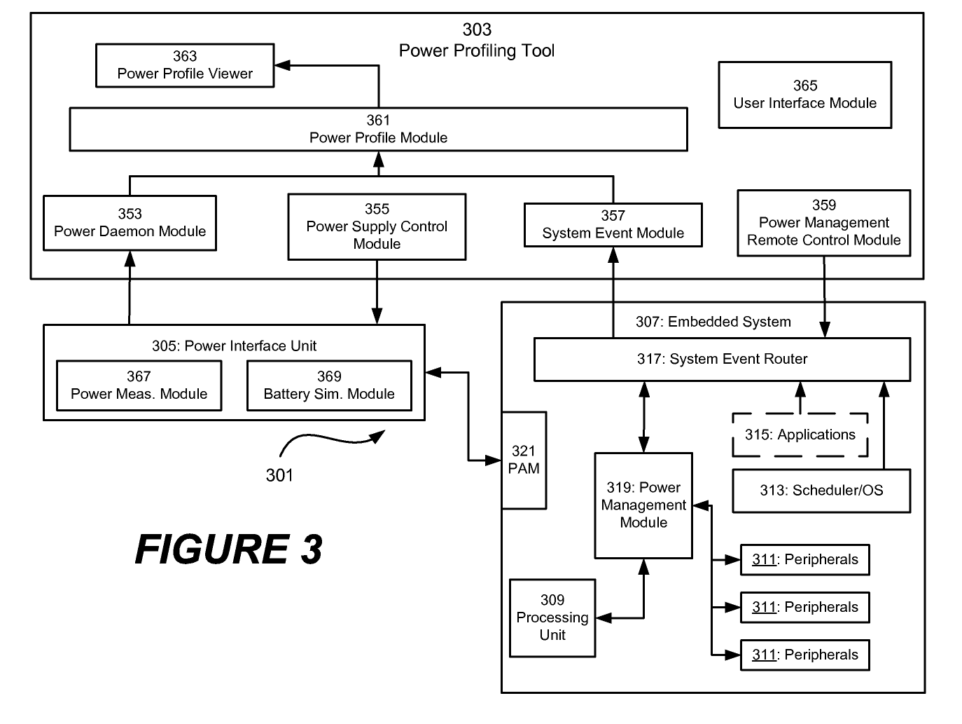

As indicated above, various implementations of the present invention are directed towards profiling the power consumption of an embedded system. FIG. 3 illustrates a power profiling system 301, which may be provided by various implementations of the present invention. As can be seen from this figure, the system 301 includes a power profiling tool 303, a power interface unit 305, and an embedded system 307. The power profiling system 301 is made from a combination of hardware and software components. These components will be described in greater detail below with reference to FIG. 3 and various other figures that highlight various illustrative implementations and uses for the system 301.

The embedded system 307 includes similar components to the illustrative embedded system referenced above in FIG. 1. More particularly, the embedded system 307 includes a processing unit 309 and various peripherals 311. As will be appreciated by those of skill in the art, the peripherals 311 may be any number and combination of hardware components available. For example, in some implementations, a one of the peripherals may be a liquid crystal display (LCD) device, while another peripheral may be a global positioning system (GPS) radio. As will be further appreciated by those of skill in the art, the type and combination of possible peripherals 311 is extensive. As a result, no attempt is made herein to create an exhaustive list. Furthermore, the different types of peripherals reverenced herein, particularly in describing the illustrative uses of the invention below shall not be taken as limiting.

The embedded system 307 further includes an operating system and scheduler 313 (i.e. firmware) and may include applications 315. Additionally, the embedded system includes a system event router 317 and a power management module 319. The system event router 317 and power management module 319 will be discussed in greater detail below. The embedded system 307 further includes a power access module 321, which is used to interface to the power interface unit 305.

The power profiling tool 303 includes a power daemon module 353, a power supply control module 353, a system event module 357, a power management remote control module 359, a power profile module 361, a power profile viewer module 363, and a user interface module 365.

In various implementations of the present invention, the power profiling tool 303 is used as an interface for the user of the system 301. More specifically, the user interface module 365 is configured to receive input from and provide output to a user of the system 301. The module 365 may interface with the other modules in the tool 303 to facilitate control and use of the tool 303 by a user of the system 301. The tool 301 may, in some implementations, be software executable instructions, executable by a general purpose computing device. With some implementations, one or more of the modules of the tool 303 may be executed on one or more computing devices, such as, for example, the computing system 201 of FIG. 2.

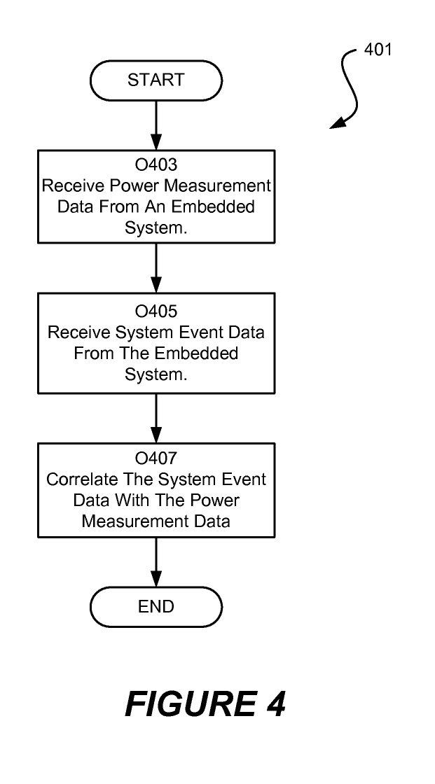

As can be seen from FIG. 4, the power daemon module 353 and the power supply control module 355 are interconnected to the power interface unit 305. As can be further seen, the power interface unit 305 includes a power measurement module 367 and a battery simulation module 369. The power measurement module 367 collects power readings from the power access module 321. In various implementations, the power access module 321 allows sampling of the supply voltage and current for the embedded system 307. With some implementations, the sampling frequency is greater than or at least equal to the frequency of the processing unit 309. The power access module 321 is also configured to regulate the supply voltage and current to the embedded system 307 based upon the battery simulation module 369.

The power daemon module 353 may then collect the power readings from the power measurement module 367. Additionally, the power supply control module 355 may dictate the supply current to the battery simulation module 369, which will in turn control the current supplied to the embedded system 307 as detailed above. By limiting the current supplied to the embedded system 307 in a controlled fashion, various batteries may be simulated. As those of skill in the art will appreciate, a battery is capable of supplying a limited amount of current over time. As such, by controlling the current supply, battery life and usage may be simulated and profiled. In various implementations, various types of power supply events may be simulated by controlling the supply through the battery simulation module 369. For example, an interruption in the power supply can be simulated, either a long duration interruption or a short interruption. Additionally, various levels of voltage drops may be simulated. For example, a progressive drop in voltage may simulate a battery that is nearing the end of its charge.

FIG. 4 also illustrates that the system event module 357 is interconnected to the system event router 317 within the embedded system 307. Furthermore, as can be seen, the system event router 317 is interconnected to a number of different components within the embedded system 307, such as, for example, the applications 315, the scheduler and operating system 313, and the power management module 319. The power management module is, in turn, interconnected to the various hardware components within the embedded system 307, such as, for example, the processing unit 309 and the peripherals 311. The system event router 317 collects power system events from the various components of the embedded system 317 and relays these to the system event module 357.

In various implementations, the system event router is a software component that collects instantaneous activity within the embedded system 307. In some implementations, the priority of the system event router 317 is low, such that, interference with the normal functioning of the embedded system 307 is minimized. With some implementations, the system event router 317 is configured to collect activity regarding the types of tasks scheduled by the scheduler and operating system 313. The system event router 317 may also be configured to collect processing activity, such as, for example, processor core voltage and frequency changes. The peripheral 311 activity (i.e. change in power state) may be collected. For example, is a peripheral 311 were a liquid crystal display, then when the peripheral 311 switched from on to off, that may be recorded. Alternatively, or additionally, when the peripheral switched brightness settings, the change in brightness setting may also be recorded.

As those of skill the art will appreciate, a number of different “events” may be collected via the system event router 317. In some implementations, the type of events collected will be dictated by a user of the system 301. In other implementations, the type of events collected will be dictated by the embedded system 307, such as, for example, the processing unit 309 architecture and peripheral 311 types may dictate the type of events collected.

The different system and power events collected from the system event router 317 are then communicated to the system event module 357. The system event module 357 then, in turn, makes these events available to the power profile module 361. The power management remote control module 359 is configured to send user provided power system commands to the embedded system 307 thought the system event router 317 and the power management module 319, this will be discussed in greater detail below.

As stated, the power profile module 361 receives event data and power measurement data from the various sub-systems of the system 301. The power profile module 361 then can correlate the received events with the received power measurement readings. In various implementations, the power profile module 361 maintains a common time base between the received events and the received measurement data so that system events and power readings can be correlated in time.

The power profile viewer 363 allows for the viewings and post processing of these received power measurements and system events. In various implementations, this is presented as a waveform or “trace.” With some implementations, the power profile viewer may display these traces in real-time as the trace data is received from the various components of the system 301. Additionally, the power profile viewer 363 may present various analyses performed by the power profile module 361. For example, the distribution of energy per peripheral 311 during a test run may be presented. Additionally, the distribution of energy per thread executed by the operating system 313 may be presented. More details about power profiling for software applications in an embedded system environment are discussed in U.S. patent application Ser. No. 12/697,291, entitled “Power Profiling for Embedded System Design,” filed on Jan. 31, 2010, and naming Glenn Perry et al. as inventors, which application is incorporated entirely herein by reference.

In various implementations, the power profile viewer 363 may plot the power measurement and the power events data over time. In alternative implementations, the power profile viewer 363 may perform post processing functions, such as, for example, subtraction, addition, division, integration, etc. of the various power measurement data.

FIG. 4 illustrates a method 401 of power profiling which may be provided by various implementations of the present invention. As can be seen from this figure, the method 401 includes an operation 403 for receiving power measurement data from an embedded system, an operation 405 for receiving system event data from an embedded system, and an operation 407 for correlating the system event data with the power measurement data.

### Illustrative Use Cases

As stated above, various implementations of the invention provide apparatuses and methods for profiling the power consumption of an embedded system. The following describe various illustrative use cases which the detailed apparatuses and methods may be used to perform. As further stated above, the following use cases are not taken to be limiting, but instead should be understood to further highlight and illustrate the various implementations of the invention.

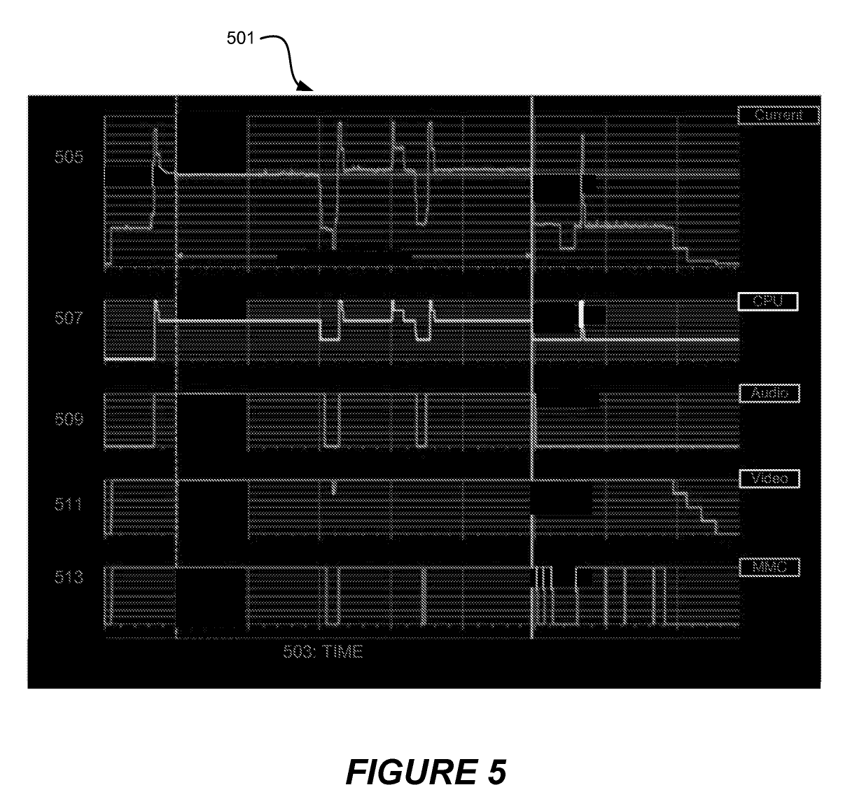

FIG. 5 illustrates a trace waveform view 501, which shows instantaneous power consumption compared with various other system events over time. More specifically, the time 503 is plotted on the ‘X’ axis, and various other metrics are plotted together to show the correlation between power consumption of system activity. The total power consumed 505 is shown. Furthermore, the processing unit 309 operating point 507 is shown. As those of skill in the art will appreciate, the voltage and frequency settings for a processing unit are often referred to as the “operating point.” Additionally, a one of the peripherals 311 (e.g. an audio driver) power state (i.e. on or off) is shown at 509, another one of the peripherals 311 (e.g. an LCD display) power state (e.g. on, off, or brightness level) is shown at 511, lastly, another one of the peripherals 311 (e.g. an SD-MMC memory reader) power state (e.g. on or off) is shown as 513.

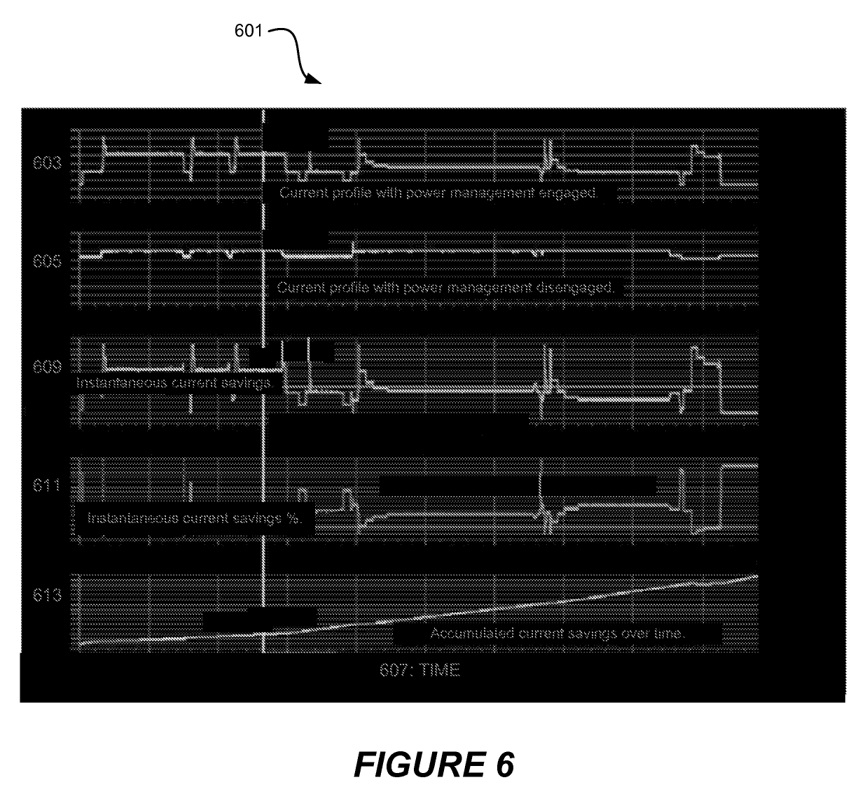

FIG. 6 illustrates a trace waveform view 601, which shows instantaneous power consumption from a first use case 603 and a second use case 605 over time 607. Furthermore, the instantaneous power savings (e.g. derived by subtracting the second use case trace 605 from the first use case trace 605) is shown at 609. This instant power saving is also represented as a percentage of total power (e.g. derived by subtracting then dividing the traces) at 611. Furthermore, the power savings over time is represented (e.g. derived by integrating the traces) at 613.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. An apparatus for profiling the power consumption of an embedded system, the apparatus comprising:
a system event routing module configured to record system events from an embedded system having a processing unit and one or more peripherals;
a power measurement unit configured to repeatedly measure the power consumption of an embedded system;
a power profile module configured to receive the recorded system events and the measured power consumption; and
a power profile viewer configured to generate a display of a power profile for the embedded system based in part upon the recorded system events and the measured power consumption.
